(19) United States
(12) Patent Application Publication
(10) Pub. No.: US 2008/0056373 A1
(43) Pub. Date: Mar. 6, 2008

(54) Method and system for dynamic frequency adjustment during video decoding

(76) Inventors: John B. Newlin, San Carlos, CA (US); Benedictus I. Tjandrasuwita, Dublin, CA (US)

Correspondence Address: NVIDIA C/O MURABITO, HAO & BARNES LLP, TWO NORTH MARKET STREET, THIRD FLOOR, SAN JOSE, CA, 95113, US

(21) Appl. No.: 11/512,873

(22) Filed: Aug. 29, 2006

(51) Int. Cl. H04N 11/04; H04N 11/02

(52) U.S. Cl. 375/240.23; 375/240.25

(57) ABSTRACT

A method and system for dynamic frequency adjustment during video decoding. A decode time for performing a hardware variable length decode (VLD) on a portion of a video clip at a processor is measured. A frequency controlling the processor during video decoding is adjusted based at least in part on the decode time.

### FIELD OF THE INVENTION

The field of the present invention pertains to video decoding. More particularly, the present invention relates to method of dynamic frequency adjustment during video decoding.

### BACKGROUND OF THE INVENTION

Many video standards, such as Moving Pictures Experts Group (MPEG) standards, e.g., MPEG-3 and MPEG-4, and the H.264 standard, include a variable length decode (VLD) operation during a video decode. In a hardware video decoder, the VLD operation may be executed at a particular processor, such as an audio/video processor (AVP). MPEG and H.264 video encoding is complex, and there may be variations in the bit rate depending on the compression ratio. Variations in bit rate cause fluctuations in how fast the AVP needs to be clocked in performing the VLD operation. In other words, frames of video may require variable amounts of processing time in performing the VLD operation.

In a typical hardware video decoding system, VLD operations are performed by enabling the system to decode at the highest processing speed required for decoding a video clip. The highest processing speed is the “worst case” processing speed, and is selected by determining the highest bit rate of video clips that can be decoded by the system. For instance, the worst case frequency may be hardwired into the system at the manufacturing facility prior to shipment. The selection of a worst case frequency may be based on an analysis of video clips received from a customer during design of the hardware video decoding system. In particular, typical hardware video decoding systems do not provide for changing frequency operating an AVP during a video decode operation.

For hardware video decoding systems implemented within a computer system having a constant power supply, such as a desktop computer, clocking the AVP at the highest frequency results in reduced usage time, but also results in increased power consumption. However, a typical hardware video decoding system implemented within a battery-powered portable computing device, where the AVP consumes the power required to decode a worst case video clip even for video clips not requiring decoding at such a high frequency, will suffer excess and unnecessary power consumption. The excess power consumption effectively reduces the usage time for the portable computing device, as the battery will require recharging sooner. Moreover, while other hardware video decoding systems use clock gating to conserve power, the clock tree of these systems continues to toggle, also resulting in excessive and unnecessary power consumption.

### SUMMARY OF THE INVENTION

Embodiments of the present invention provide for dynamic frequency adjustment during video decoding. Embodiments of the present invention are capable of adaptively adjusting the frequency of an audio/video processor (AVP) during video decoding. Embodiments of the present invention provide for reducing power consumption of an AVP by reducing unused processing frequency.

In one embodiment, the present invention provides a method of dynamic frequency adjustment during video decoding. A decode time for performing a hardware variable length decode (VLD) on a portion of a video clip at a processor is measured. In one embodiment, the processor is an audio/video processor of a graphics processing unit (GPU). In one embodiment, the portion comprises a plurality of frames of the video clip, and an average decode time for each of the plurality of the frames is determined by averaging the decode time for the plurality of the frames.

A frequency controlling the processor during the video decoding of the video clip is adjusted based at least in part on the decode time. In one embodiment, the decode time is compared to an allotted decode time based on the frequency. If the decode time is different than the allotted decode time, the frequency is adjusted. In one embodiment, if the decode time is greater than the allotted decode time, the frequency is increased, and if the decode time is less than the allotted decode time, the frequency is decreased. In one embodiment, the frequency is adjusted subject to a maximum frequency adjustment limitation. In one embodiment, the frequency is linearly scaled according to the average decode time. In one embodiment, the frequency is generated at a clock of a host processor.

In another embodiment, the present invention provides a video decoding system including an audio/video processor for performing a variable length decode (VLD) on a portion of a video clip, a decode timer for measuring a decode time for performing the VLD operation for the portion, a clock for generating a frequency at which the audio/video processor performs the VLD operation; and an adaptive clock frequency control for adjusting the frequency based at least in part on the decode time. In one embodiment, the clock and the adaptive clock frequency control are comprised within a host processor and wherein the audio/video processor is comprised within a graphics processing unit (GPU).

In one embodiment, the portion includes a plurality of frames of the video clip, and the adaptive clock frequency control is operable to determine an average decode time for each of the plurality of the frames by averaging the decode time for the plurality of the frames. In one embodiment, the adaptive clock frequency control comprises a moving average filter for determining the average decode time for the plurality of the frames. In one embodiment, the adaptive clock frequency control is operable to compare the decode time to an allotted decode time based on the frequency, and is operable to adjust the frequency if the decode time is different than the allotted decode time. In one embodiment, the adaptive clock frequency control is operable to increase the frequency if the decode time is greater than the allotted decode time, and is operable to decrease the frequency if the decode time is less than the allotted decode time. In one embodiment, the adaptive clock frequency control is operable to adjust the frequency subject to a maximum frequency adjustment limitation. In one embodiment, the adaptive clock frequency control is operable to linearly scale the frequency according to the average decode time.

In another embodiment, the present invention provides an adaptive clock frequency control for an audio/video processor including an average decode time module for determining an average decode time for a plurality of frames of a video clip, wherein the average decode time is a total time for performing a variable length decode (VLD) at the audio/video processor on the plurality of the frames divided by the plurality of frames, and an adaptive frequency adjuster for adjusting a frequency controlling the VLD based at least in part on said average decode time.

In one embodiment, the average decode time module includes a moving average filter. In one embodiment, the adaptive frequency adjustor is operable to compare the average decode time to an allotted decode time based on the frequency, and is operable to adjust the frequency if the average decode time is different than the allotted decode time. In one embodiment, the adaptive frequency adjustor is operable to increase the frequency if the average decode time is greater than the allotted decode time, and is operable to decrease the frequency if the average decode time is less than the allotted decode time. In one embodiment, the adaptive frequency adjustor is operable to adjust the frequency subject to a maximum frequency adjustment limitation. In one embodiment, the adaptive frequency adjustor is operable to linearly scale the frequency according to the average decode time. In one embodiment, wherein the adaptive clock frequency control is comprised within a host processor and wherein the audio/video processor is comprises within a graphics processing unit (GPU).

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an overview diagram of the basic components of a computer system, in accordance with one embodiment of the present invention.

FIG. 2 illustrates a block diagram of a host processor for adaptively controlling clock frequency, in accordance with one embodiment of the present invention.

FIG. 3 illustrates a block diagram of a graphics processing unit (GPU) including a variable length decode (VLD), in accordance with one embodiment of the present invention.

FIG. 4 illustrates a flow chart of a process of dynamic frequency adjustment during video decoding, in accordance with an embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

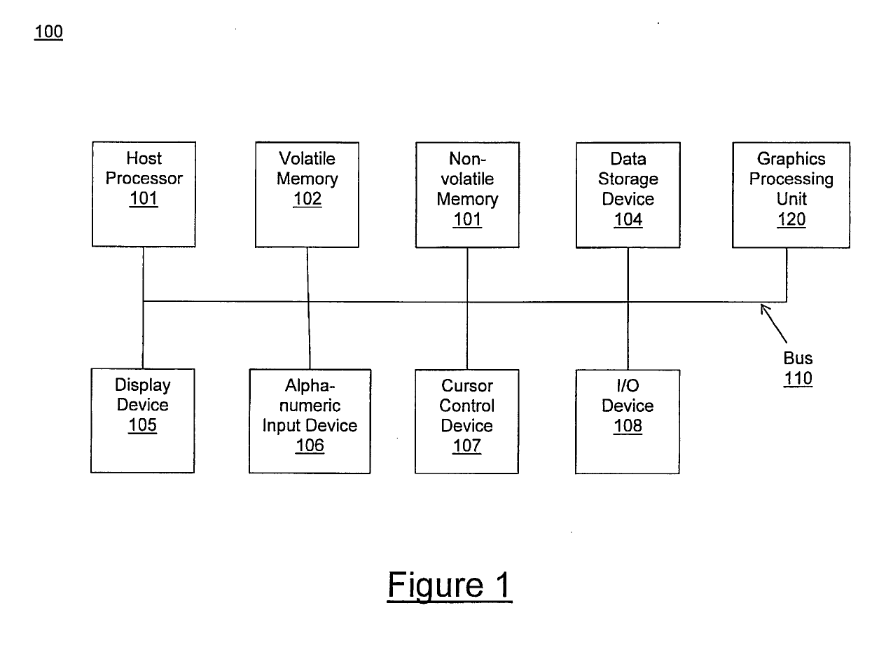

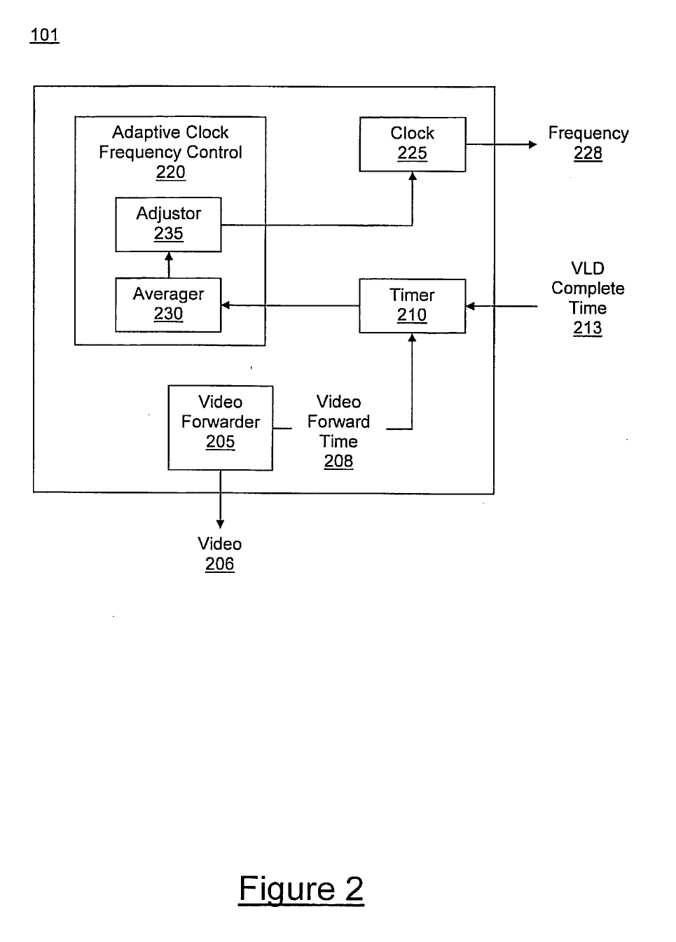

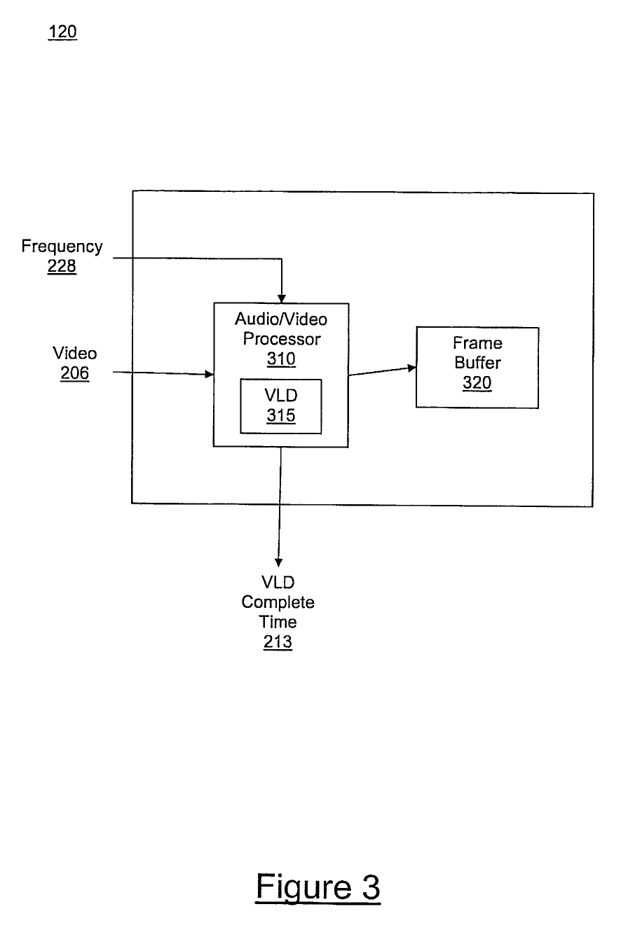

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “performing” or “measuring” or “adjusting” or “determining” or “comparing” or “increasing” or “decreasing” or “controlling” or “scaling” or “buffering” or “ordering” or “forwarding” or “parsing” or “interleaving” or “rotating” or “repositioning” or “storing” or the like, refer to the action and processes of a video decoding system, e.g., host processor 101 of FIGS. 1 and 2 and graphics processing unit (GPU) 109 of FIGS. 1 and 3, or similar electronic computing device, that manipulates and transforms data represented as physical (electronic) quantities within the computer system's registers and memories into other data similarly represented as physical quantities within the computer system memories or registers or other such information storage, transmission or display devices.

### Computer System Platform:

FIG. 1 illustrates an exemplary computer system 100 upon which embodiments of the present invention may be practiced. In general, computer system 100 comprises bus 110 for communicating information, processor 101 coupled with bus 110 for processing information and instructions, volatile memory 102, also referred to as random access memory (RAM), coupled with bus 110 for storing information and instructions for processor 101, and nonvolatile memory 103, also referred to herein as read-only memory (ROM), coupled with bus 110 for storing static information and instructions for processor 101.

In one embodiment, computer system 100 comprises an optional data storage device 104 such as a magnetic or optical disk and disk drive coupled with bus 110 for storing information and instructions. In one embodiment, computer system 100 comprises an optional user output device such as display device 105 coupled to bus 110 for displaying information to the computer user, an optional user input device such as alphanumeric input device 106 including alphanumeric and function keys coupled to bus 110 for communicating information and command selections to processor 101, and/or an optional user input device such as cursor control device 107 coupled to bus 110 for communicating user input information and command selections to processor 101. Furthermore, an optional input/output (I/O) device 108 is used to couple computer system 100 onto, for example, a network.

In one embodiment, computer system 100 also comprises GPU 120 for providing dedicated graphics rendering functionality. GPU 120 includes a plurality of hardware decoding blocks for performing decoding operations, including a variable length decode (VLD) operation and an inverse transform operation, such as an inverse discrete cosine transform (iDCT) operation. It should be appreciated that GPU 120 may be configured to decode video according to any video encoding standard utilizing a VLD operation in decoding the video. For example, GPU 120 may be configured to decode video encoded using a Moving Pictures Experts Group (MPEG) standard, e.g., MPEG-3 and MPEG-4, or the H.264 standard.

It should be appreciated that the GPU 120 can be implemented as a discrete component, a discrete graphics card designed to couple to the computer system 100 via a connector (e.g., AGP slot, PCI-Express slot, etc.), a discrete integrated circuit die (e.g., mounted directly on the motherboard), or as an integrated decoder device included within the integrated circuit die of a computer system chipset component. Additionally, a local graphics memory can be included on GPU 120 for data storage.

### Dynamic Frequency Adjustment During Video Decoding

FIG. 2 illustrates a block diagram of a host processor 101 for adaptively controlling clock frequency, in accordance with one embodiment of the present invention. In one embodiment, host processor 101 includes adaptive clock frequency control 220 that is able to adjust frequency 228 of clock 225 based on the time it takes for a processor (e.g., AVP 310 of FIG. 3) to perform a hardware VLD operation. In one embodiment, host processor 101 is a reduced instruction set computer (RISC) processor. However, it should be appreciated that host processor 101 may be any type of microprocessor calculating a frequency for controlling a hardware video decoder.

Clock 225 of host processor 101 generates frequency signal 228. Frequency 228 is used by components of a hardware video decoding system (e.g., GPU 120) for decoding video clips. Clock 225 is dynamically controllable such that frequency 228 can be adjusted during operation of host processor 101, and without requiring a hard reset of host processor 101. In particular, frequency 228 can be adjusted during a video decode operation of a hardware video decoding system. In one embodiment, clock 225 can be incrementally adjusted, e.g., 0.5×, 2.0×, or 2.5×. In another embodiment, clock 225 operates at specific frequencies, and the operating frequency can be switched among these, e.g., 333 MHz, 666, MHz, 1.0 GHz, 1.33 GHz.

Video forwarder 205 is operable to forward portions, e.g., video 206, of a video clip or video stream to the hardware video decoding system for decoding. In one embodiment, the portions are frames of a video clip. In another embodiment, the portions are macroblocks of a video clip. It should be appreciated that the portions can be any unit of the video clip. In general, the smaller the portion, and thus the greater the number of portions requiring processing, the greater the processing speed required to perform the video decoding. While the embodiments of the present invention are described using frames of a video clip, it should be appreciated that one of skill in the art would understand how the embodiments are also applicable to other portions of a video stream, such as macroblocks. It should also be appreciated that video forwarder 205 may be implemented as a hardware component of host processor 101, a firmware component, a software component, or any combination thereof.

It should be appreciated that video forwarder 205 is operable to forward frames for decoding temporally ahead of frames for display. For example, where adaptive clock frequency control is operable to adjust frequency 228 based on the average decode time of three frames, three frames are decoded and the decode time determined ahead of frames being displayed.

Timer 210 is operable to measure the decode time required for performing a VLD operation on a hardware video decoding system. In one embodiment, video forwarder 205 notifies timer 210 upon forwarding a video frame to the hardware video decoding system. Timer 210 receives video forward time 208 from video forwarder 205. In one embodiment, video forward time 208 is the time in milliseconds that a particular portion is forwarded to the hardware video decoding system. However, It should be appreciated that format of video forward time 208 may be operating system dependent, and thus may be different according to the operating system.

In one embodiment, timer 210 receives a VLD complete time 213 from the hardware video decoding system upon completion of the VLD operation for a particular frame. Timer 210 is operable to determine the decode time for a particular frame by subtracting video forward time 208 for the frame from VLD complete time 213 for the frame. In one embodiment, the decode time for a frame is stored in a register associated with timer 210. It should be appreciated that timer 210 is configured to store any number of decode times for frames, and that time 210 may include any number of registers. In one embodiment, timer 210 is operable to maintain a histogram of decode times for a plurality of frames.

Adaptive clock frequency control 220 is operable to adjust frequency 228 of clock 225 during operation of host processor 101 based at least in part on the decode time of a frame. In one embodiment, adaptive clock frequency control 220 includes average decode time module 230, e.g., an averager, for determining an average decode time for a plurality of video frames. In one embodiment, average decode time module 230 is a moving average filter, e.g., a box filter. It should be appreciated that average decode time module 230 may include other types of filters. However, the selection of a filter is typically a design selection based in part on the processing capabilities of host processor 101.

The average decode time is the total decode time for a plurality of video frames divided by the number of frames comprising the plurality of frames. For example, timer 210 may store the decode time for three frames having decode times of thirteen, fourteen and eighteen milliseconds, respectively, where the average decode time is fifteen milliseconds.

Adaptive frequency adjustor 235 is operable to adjust frequency 228 of clock 225 based at least in part on the decode time of a frame. In one embodiment, adaptive frequency adjustor 235 is operable to adjust frequency 228 of clock 225 based at least in part on the average decode time for a plurality of video frames. In one embodiment, adaptive frequency adjuster 235 compares the average decode time to an allotted decode time based on the current value of frequency 228. The allotted decode time is the time allotted for performing a VLD operation, and is based on frequency 228. For example, the allotted decode time for decoding thirty frames per second is thirty milliseconds per frame.

Adaptive frequency adjustor 235 is operable to adjust frequency 228 if the allotted decode time is different than the average decode time. In one embodiment, adaptive frequency adjustor 235 is operable to increase frequency 228 if the decode time is greater than the allotted decode time, since the allotted decode time is not sufficient to fully decode the frame. Alternatively, if the decode time is less than the allotted decode time, adaptive frequency adjustor 235 is operable to decrease frequency 228, thereby reducing excess processing speed that is not required for performing the VLD operation. In one embodiment, adaptive frequency adjuster 235 does reduce the frequency if the next lowest frequency increment is too slow to decode the frame.

In one embodiment, adaptive frequency adjustor 235 is operable to linearly scale frequency 228 according to the average decode time. In one embodiment, the frequency is linearly scaled based on the average usage time, e.g., the average decode time divided by the allotted decode time. For example, where the allotted decode time is thirty milliseconds per frame and the average decode time is fifteen milliseconds per frame, frequency 228 is scaled down by half. In one embodiment, the new value for frequency 228 is determined by performing a linear interpolation to determine how much faster or slower the processor should have been running to decode the previous plurality of frames.

In one embodiment, adaptive frequency adjustor is operable to adjust frequency 228 subject to a maximum frequency adjustment limitation. The maximum frequency adjustment limitation is used for ensuring that the frequency does not fluctuate too much during the decoding. In one embodiment, the maximum frequency adjustment limitation limits frequency adjustments to a percentage change. In one embodiment, the maximum frequency adjustment limitation limits decreases in frequency, ensuring that frequency 228 does not go too slow. For example, the frequency adjustment may be limited to twenty-five percent reduction in frequency 228. The maximum frequency adjustment limitation may also include a minimum frequency which frequency 228 can not go below.

FIG. 3 illustrates a block diagram of a graphics processing unit (GPU) 120, in accordance with one embodiment of the present invention. GPU 120 includes hardware components for performing video decode operations. In one embodiment, GPU 120 includes AVP 310 including hardware VLD 315. It should be appreciated that GPU 120 may include other components for performing other video decoding operations, such as an inverse transform operation. These other components are well understood by those of skill in the art, and have not been described herein as not to unnecessarily obscure aspects of the embodiments of the present invention.

AVP 310 receives video 206 from host processor 101, as described above. VLD 315 performs a hardware VLD operation on video 206 according to frequency 228 as generated by clock 225. It should be appreciated that VLD 315 is configured to perform a VLD operation according to a dynamic frequency. Upon completion of the VLD operation, AVP 310 transmits VLD complete time 213 to host processor 101.

In one embodiment, GPU 120 also includes a frame buffer for buffering frames. Because AVP 310 decodes frames ahead of display, the frame buffer allows for buffering frames. In one embodiment, the video is decoded ahead of the audio decode at AVP 310. The decoded frames are merged with the decoded audio prior to display. The frame buffer is also useful for reducing the impact if a frame takes longer to decode than the current frequency. In one embodiment, the frame buffer is capable of buffering the number of frames for which the decode time is stored at host processor 101 by a constant. For example, where the decode time is stored for four frames, the frame buffer may be configured to buffer two frames.

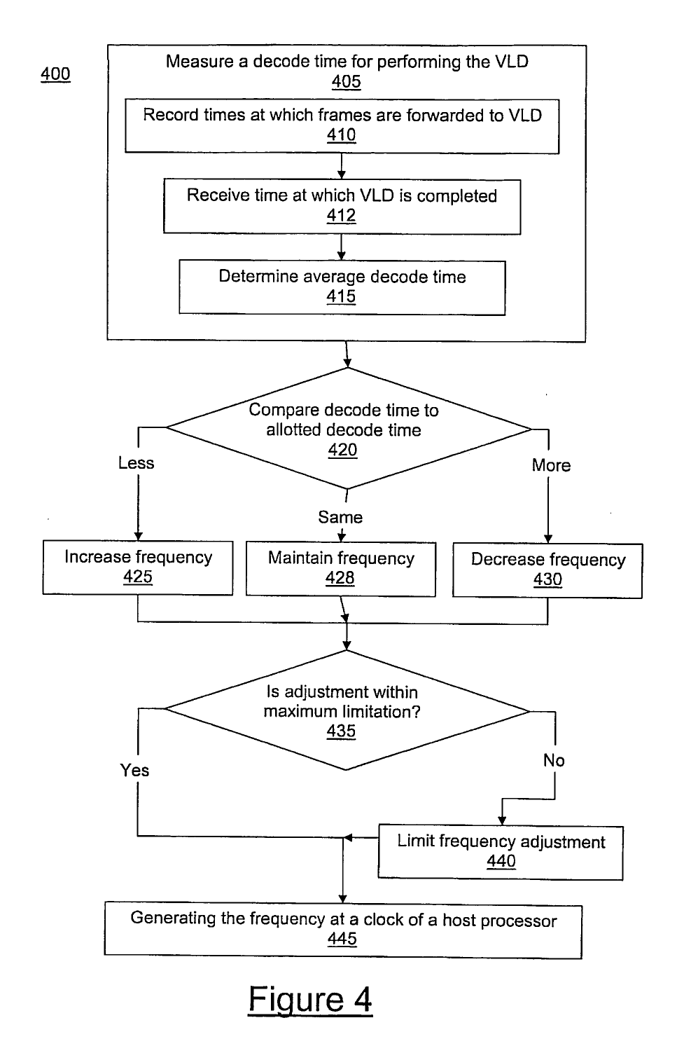

FIG. 4 illustrates a flow chart of a process 400 of dynamic frequency adjustment during video decoding, in accordance with an embodiment of the present invention. Although specific steps are disclosed in process 400, such steps are exemplary. That is, the embodiments of the present invention are well suited to performing various other steps or variations of the steps recited in FIG. 4. In one embodiment, process 400 is performed by a processor controlling a video decoding system, e.g., host processor 101 of FIG. 2 controlling GPU 120 of FIG. 3.

At step 405 of process 400, a decode time for performing a hardware variable length decode (VLD) on a portion of a video clip at a processor is measured. In one embodiment, as shown at step 410, the times at which frames are forwarded for decoding are recorded, e.g., video forward time 208. In one embodiment, as shown at step 412, the times at which the VLDs are completed for the frames are received, e.g., VLD complete time 213. In the present embodiment, the decode times for the frames are determined by subtracting the time at which a frame is forwarded for decoding from the time at which the VLD is completed. It should be appreciated that steps 410 and 412 are optional, and that the decode time for performing the VLD for a frame can be performed other ways.

In one embodiment, as shown at step 415, the average decode time for a plurality of frames is determined by averaging the decode time for the plurality of the frames. It should be appreciated that embodiments of the present invention may be performed using any positive number of frames, and that the average decode time is used for comparing to an allotted decode time.

At step 420, the decode time, e.g., the average decode time, is compared to an allotted decode time. The allotted decode time is the time allotted for performing the VLD based on the frequency controlling the VLD. If the decode time is different than the allotted decode time, the frequency is adjusted. In one embodiment, the frequency is linearly scaled based on the average usage time, e.g., the decode time divided by the allotted decode time. In one embodiment, if the decode time is greater than the allotted decode time, as shown at step 425, the frequency is increased. If the decode time is less than the allotted decode time, as shown at step 430, the frequency is decreased.

If the decode time is substantially the same as the allotted decode time, as shown at step 428, the frequency is maintained and not changed. It should be appreciated that the decode time and allotted decode time are substantially the same if both require the same minimum frequency increment of a clock operable to provide frequencies at specific increments. For instance, if the allotted decode time requires a frequency of 800 MHz and the decode time is 750 MHz, and the clock is operable at 666 MHz and 1.0 GHz, the allotted decode time and decode time are substantially similar because they both require the frequency 1.0 GHz.

At step 435, it is determined whether the adjustment is within a maximum frequency adjustment limitation. For example, the maximum frequency adjustment limitation may restrict decreasing the frequency by more than twenty-five percent. If the adjustment is within the maximum frequency adjustment limitation, e.g., not greater than twenty-five percent, process 400 proceeds to step 445. If the adjustment is not within the maximum frequency adjustment limitation, e.g., greater than twenty-five percent, the adjustment is limited according to the maximum frequency adjustment limitation, as shown at step 440.

At step 445, the frequency is generated at a clock of the host processor subject to any adjustments.

Embodiments of the present invention provide a method and system for dynamic frequency adjustment during video decoding. Embodiments of the present invention are capable of adaptively adjusting the frequency controlling a hardware VLD during video decoding. Embodiments of the present invention are capable of adjusting the frequency at a frame level granularity. Other embodiments of the invention are capable of adjusting the frequency at a macroblock-level granularity. By adaptively adjusting the frequency during video decoding based on a recent history of how long it took to perform a VLD, excess power loss caused by unused processing speed is reduced. If the decode occurred faster than required, the frequency can be reduced to slow the VLD down, thus saving power.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of dynamic frequency adjustment during video decoding, said method comprising:
measuring a decode time for performing a hardware variable length decode (VLD) on a portion of a video clip at a processor; and
adjusting a frequency controlling said processor during said video decoding of said video clip based at least in part on said decode time.

2. The method as recited in claim 1 wherein said portion comprises a plurality of frames of said video clip, and wherein said method further comprises determining an average decode time for each of said plurality of said frames by averaging said decode time for said plurality of said frames.

3. The method as recited in claim 1 wherein said adjusting a frequency controlling said processor based on said decode time comprises:
comparing said decode time to an allotted decode time based on said frequency;
if said decode time is different than said allotted decode time, adjusting said frequency.

4. The method as recited in claim 3 further comprising:
if said decode time is greater than said allotted decode time, increasing said frequency; and
if said decode time is less than said allotted decode time, decreasing said frequency.

5. The method as recited in claim 3 further wherein said adjusting said frequency comprises adjusting said frequency subject to a maximum frequency adjustment limitation.

6. The method as recited in claim 2 wherein said adjusting said frequency controlling said processor based at least in part on said decode time comprises linearly scaling said frequency according to said average decode time.

7. The method as recited in claim 1 wherein said processor is an audio/video processor of a graphics processing unit (GPU).

8. The method as recited in claim 1 further comprising generating said frequency at a clock of a host processor.

9. The method as recited in claim 1 wherein said portion comprises a plurality of macroblocks of said video clip, and wherein said method further comprises determining an average decode time for each of said plurality of said macroblocks by averaging said decode time for said plurality of said macroblocks.

10. A video decoding system comprising:
an audio/video processor for performing a variable length decode (VLD) on a portion of a video clip;
a decode timer for measuring a decode time for performing said VLD operation for said portion;
a clock for generating a frequency at which said audio/video processor performs said VLD operation; and
an adaptive clock frequency control for adjusting said frequency based at least in part on said decode time.

11. The video decoding system as recited in claim 10 wherein said portion comprises a plurality of frames of said video clip, and wherein said adaptive clock frequency control is operable to determine an average decode time for each of said plurality of said frames by averaging said decode time for said plurality of said frames.

12. The video decoding system as recited in claim 11 wherein said adaptive clock frequency control comprises a moving average filter for determining said average decode time for said plurality of said frames.

13. The video decoding system as recited in claim 10 wherein said adaptive clock frequency control is operable to compare said decode time to an allotted decode time based on said frequency, and is operable to adjust said frequency if said decode time is different than said allotted decode time.

14. The video decoding system as recited in claim 13 wherein said adaptive clock frequency control is operable to increase said frequency if said decode time is greater than said allotted decode time, and is operable to decrease said frequency if said decode time is less than said allotted decode time.

15. The video decoding system as recited in claim 13 further wherein said adaptive clock frequency control is operable to adjust said frequency subject to a maximum frequency adjustment limitation.

16. The video decoding system as recited in claim 11 wherein said adaptive clock frequency control is operable to linearly scale said frequency according to said average decode time.

17. The video decoding system as recited in claim 10, wherein said clock and said adaptive clock frequency control are comprised within a host processor and wherein said audio/video processor is comprised within a graphics processing unit (GPU).

18. The video decoding system as recited in claim 10 wherein said portion comprises a plurality of macroblocks of said video clip, and wherein said adaptive clock frequency control is operable to determine an average decode time for each of said plurality of said macroblocks by averaging said decode time for said plurality of said macroblocks.

19. An adaptive clock frequency control for an audio/video processor, said adaptive clock frequency control comprising:
an average decode time module for determining an average decode time for a plurality of frames of a video clip, wherein said average decode time is a total time for performing a variable length decode (VLD) at said audio/video processor on said plurality of said frames divided by said plurality of frames; and
an adaptive frequency adjuster for adjusting a frequency controlling said VLD based at least in part on said average decode time.

20. The adaptive clock frequency control as recited in claim 19 wherein said average decode time module comprises a moving average filter.

21. The adaptive clock frequency control as recited in claim 19 wherein said adaptive frequency adjustor is operable to compare said average decode time to an allotted decode time based on said frequency, and is operable to adjust said frequency if said average decode time is different than said allotted decode time.

22. The adaptive clock frequency control as recited in claim 21 wherein said adaptive frequency adjustor is operable to increase said frequency if said average decode time is greater than said allotted decode time, and is operable to decrease said frequency if said average decode time is less than said allotted decode time.

23. The adaptive clock frequency control as recited in claim 19 wherein said adaptive frequency adjustor is operable to adjust said frequency subject to a maximum frequency adjustment limitation.

24. The adaptive clock frequency control as recited in claim 19 wherein said adaptive frequency adjustor is operable to linearly scale said frequency according to said average decode time.

25. The adaptive clock frequency control as recited in claim 19, wherein said adaptive clock frequency control is comprises within a host processor and wherein said audio/video processor is comprised within a graphics processing unit (GPU).
